(19) United States
(12) Patent Application Publication
(10) Pub. No.: US 2026/0014596 A1
(43) Pub. Date: Jan. 15, 2026

(54) BRUSH POLE ASSEMBLY WITH INTEGRATED AIR SYSTEM

(71) Applicant: Cairn Engineering LLC, Louisville, CO (US)

(72) Inventors: Christopher Esser, Cousiville, CO (US); Matthew Burns, Louisville, CO (US)

(21) Appl. No.: 19/267,370

(22) Filed: Jul. 11, 2025

Related U.S. Application Data
(60) Provisional application No. 63/671,212, filed on Jul. 14, 2024.

(51) Int. Cl. B08B 5/02; B08B 1/12; B08B 1/30; B25G 1/06; B25G 3/20

(52) U.S. Cl. CPC B08B 5/02; B08B 1/12; B08B 1/30; B25G 1/06; B25G 3/20

(57) ABSTRACT

A cleaning device includes a grip comprising a fan, a battery, and a switch configured to power the fan; a pole having a proximal end coupled to the grip and a distal end, the pole defining a first internal channel in fluid communication with the fan; and a head portion coupled to the distal end of the pole and including an articulating hinge defining a second internal channel aligned with the first internal channel and an aperture. The fan is configured to draw air from the grip through the first and second internal channels and expel it through the aperture to dislodge friction inhibiting debris.

### CROSS REFERENCE TO RELATED APPLICATIONS

This application claims priority to U.S. Provisional Patent Application No. 63/671,212 filed on Jul. 14, 2024, entitled “BRUSH POLE ASSEMBLY WITH INTEGRATED AIR SYSTEM,” which is hereby incorporated herein by reference in its entirety.

### TECHNICAL FIELD

The present disclosure relates generally to rock climbing wall systems, and more particularly to the cleaning thereof.

### BACKGROUND

The sport of climbing relies on the climber to grasp a climbing surface to mobilize their bodies up and across a feature; such as a wall, or rock. The efficacy of the climbers' movements is reliant, in all contexts, on the coefficient of friction between the climbers' body and the climbing surface. Magnesium Carbonate (aka climber's chalk) is a preferred substance used by climbers to reduce the effects of exercise and fear induced palmar sweating, by way of adsorption of perspiration, and in some cases, chalk increases the coefficient of friction between the climbers' skin and the rock via intermolecular forces. However, excessive build-up of chalk, mixed with climbers' skin, lipids, and shoe rubber and other natural sources like dirt, leaves, or water on the climbing surfaces may decrease the apparent friction between climbers' body and the climbing surfaces.

Approaches for cleaning surfaces often include bristled brushes manually manipulated by a user to remove detritus and other materials from the intended surfaces. In climbing applications, bristled brushes of various sizes, including variations to the heel, belly and toe may be used to accomplish the removal of chalk and dirt from climbing surfaces, such as rock or plastic. In some cases, the bristle type and thickness can be modified to achieve greater detritus removal rates from irregular surfaces common to rock climbing surfaces.

Another approach has been the use of poles, such as a painter's pole, or in some cases a climbing-specific pole. Such poles can also include a mounting mechanism to accommodate specific rock-climbing brushes. Additionally, the mounting mechanism may include movable components allowing a user to adjust the orientation of the brush, allowing it to clean climbing surfaces that are convex, concave, or any combination thereof.

Traditional stick brushes may even sometimes be an actual tree branch with a brush attached via athletic tape to allow the user to clean out of reach holds. A user may use their own breath to remove dust or debris from a climbing surface.

### SUMMARY

Embodiments of the present disclosure are directed to a brush pole assembly with an integrated air system for use as a cleaning device, particularly well-suited for dislodging dust, chalk, and other debris from surfaces such as rock-climbing holds. The device integrates a powered air blower with a mechanical brush on an extendable pole, allowing a user to simultaneously scrub and blow away particulate matter from hard-to-reach areas. The core of the device consists of a handle or grip portion, an elongated pole, and an adjustable head portion.

In one embodiment, the grip houses a battery-powered fan, a switch, and control circuitry. This grip is configured to be detachable from the main pole, and stored separately or while charging the battery. The pole, which may be a telescoping pole, and which may consist of several nested sections with locking mechanisms, defines an internal channel. This channel serves as a conduit for air to travel from the fan in the grip to the head of the device. The head portion is coupled to the pole via an articulating hinge, which also contains an internal air channel. This hinge allows the head to be locked into various angular positions relative to the pole, providing optimal cleaning angles for different surfaces.

The head portion is designed to receive a removable cleaning brush, which can be secured by a slot and an adjustable clamp. An aperture in the head directs the stream of air from the internal channels. The airflow path is specifically designed to travel from the grip, through the pole, and through the articulating hinge, after which it may be accelerated by a nozzle before exiting the aperture. In many configurations, the aperture is positioned to direct the air orthogonally across the bristles of the attached brush, creating a powerful, combined cleaning action. A method for using the device involves adjusting its length and angle, activating the fan, and directing the brush and airflow at a surface to dislodge debris.

Embodiments of the present disclosure to removal of detritus from climbing surfaces by incorporating a nozzle to deliver pressurized air to the climbing surface while being brushed. Embodiments of the present disclosure include a hollow pole with the ability to attach a motor and fan on a gripping end of the device and a head unit on the other end of the device, where the hollow pole separates the gripping end from the head unit. In some cases, the gripping unit fan and motor deliver pressurized air through the hollow pole, or aperture within the pole, to the head unit. The head unit can be configured to have a nozzle that can deliver the pressurized air at a specified angle and spray configuration towards the surface making contact with the bristles of the brush attached to the head unit, wherein the nozzle can be directed to blow near the brush, across the bristles of the brush, or without the brush. The head unit may also include a cavity that can accommodate and secure a brush.

Embodiments include one, more, or any combination of the various apparatuses and methods described herein. Other features and advantages of the present disclosure will become apparent from the following more detailed description, taken in conjunction with the accompanying, which illustrate, by way of example, the principles of the disclosure.

### BRIEF DESCRIPTION OF THE DRAWINGS

FIG. 1 illustrates a cross-section elevation view of a cleaning device, according to embodiments of the present disclosure.

FIG. 2 illustrates a cross-section elevation view of a cleaning device grip, according to embodiments of the present disclosure.

FIG. 3 illustrates a perspective view of a cleaning device grip, according to embodiments of the present disclosure.

FIG. 4 illustrates an elevation view of a cleaning device grip, according to embodiments of the present disclosure.

FIG. 5A illustrates a perspective view of a cleaning device head portion, according to embodiments of the present disclosure.

FIG. 5B illustrates a cross-section elevation view of a cleaning device head portion, according to embodiments of the present disclosure.

FIG. 6A illustrates an elevation view of a cleaning device head portion, according to embodiments of the present disclosure.

FIG. 6B illustrates an elevation view of a cleaning device head portion, according to embodiments of the present disclosure.

FIG. 7 illustrates a cross-section elevation view of a cleaning device head portion, according to embodiments of the present disclosure.

FIG. 8 illustrates a cross-section elevation view of a cleaning device, according to embodiments of the present disclosure.

FIG. 9 illustrates a perspective view of a cleaning device head portion, according to embodiments of the present disclosure.

FIG. 10 illustrates a perspective view of a cleaning device, according to embodiments of the present disclosure.

FIG. 11 illustrates a cross-section view of a cleaning device, according to embodiments of the present disclosure.

Corresponding reference characters indicate corresponding parts throughout the several views.

While the disclosure is amendable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The following detailed description illustrates embodiments of the disclosure and manners by which they can be implemented. Although the best mode of carrying out the present disclosure has been disclosed, those skilled in the art would recognize that other embodiments for carrying out or practicing the present disclosure are also possible.

It should be noted that the terms “first,” “second,” and the like, herein do not denote any order, quantity, or importance, but rather are used to distinguish one element from another. Further, the terms “a” and “an” herein do not denote a limitation of quantity, but rather denote the presence of at least one of the referenced items.

The various components of the cleaning device may be fabricated from any suitable durable and lightweight materials. For instance, the grip housing, head portion, and components of the articulating hinge may be formed from rigid polymers or plastics through processes such as injection molding or 3D printing. Suitable plastics include, but are not limited to, Acrylonitrile Butadiene Styrene (ABS), polycarbonate (PC), reinforced nylon, or polypropylene (PP), which offer high impact resistance and manufacturability. For components requiring higher strength or a different aesthetic, such as the pole or internal fastening hardware, metals like anodized aluminum, stainless steel, or metal alloys may be used. In some cases, composites, thermosets, and or thermos plastics may be used, such as fiberglass acrylic, carbon fiber, or fiber reinforced high density polyethylene (HDPE). Furthermore, portions of the grip may include an over-molded elastomeric material, such as a Thermoplastic Elastomer (TPE) or silicone, to enhance user comfort, grip, and vibration damping.

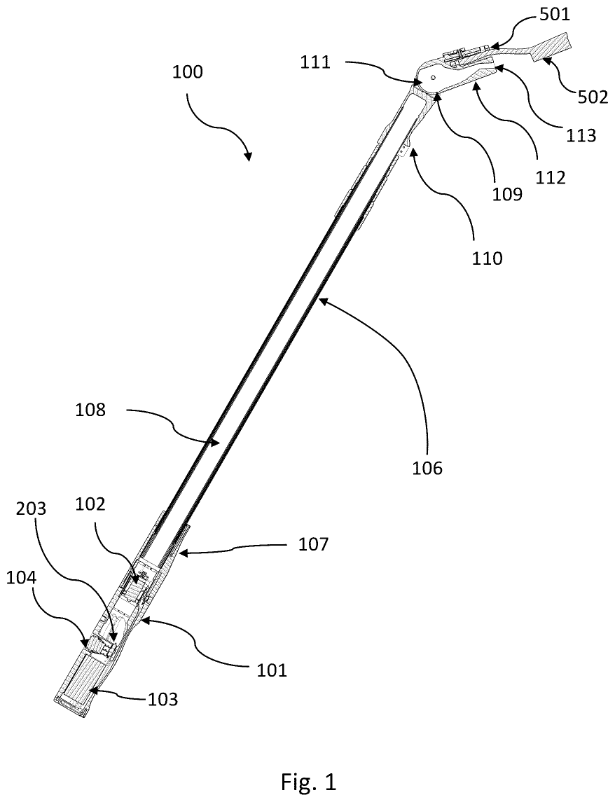

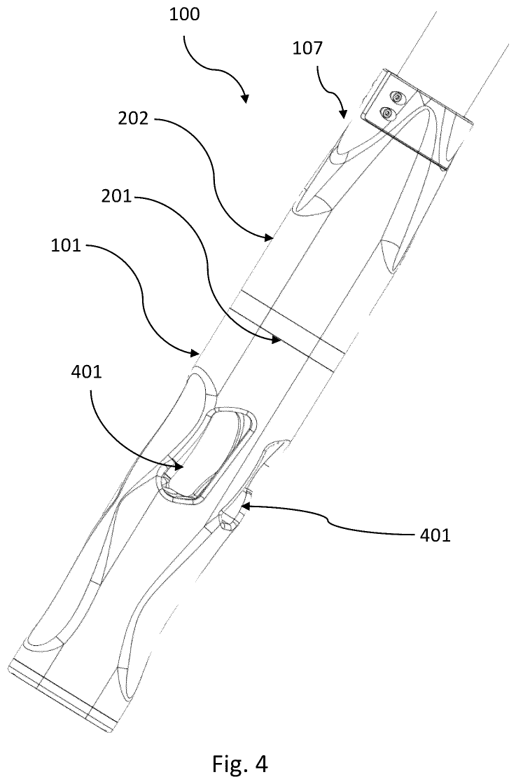

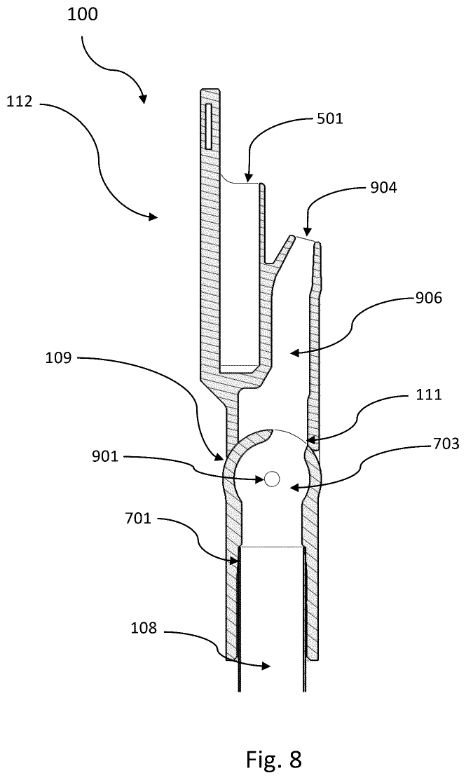

As shown in FIGS. 1, 2, 3, 4, 5A, 5B, 6A, 6B, 7, 8, 9, and 10, in some aspects, the techniques described herein relate to a cleaning device 100 that has a grip 101 including a fan 102, a battery 103, a switch 104, and a PCB 105. In some cases, the battery 103 is configured to power the fan 102 via the switch 104 and the PCB 105.

In some aspects, the fan 102 is configured to generate a directed stream of air with sufficient velocity to dislodge, aka remove, debris via the aperture 113 with the pole 106 being between a length of one-half meter and up a length of three and one-half meters (0.5 m-3.5 m). The fan 102 may be any type of compact air-moving device suitable for a battery-powered application. In some cases, the grip 101, also comprises a grill 204 configured to prevent debris and/or a user's digit from contacting the fan 102

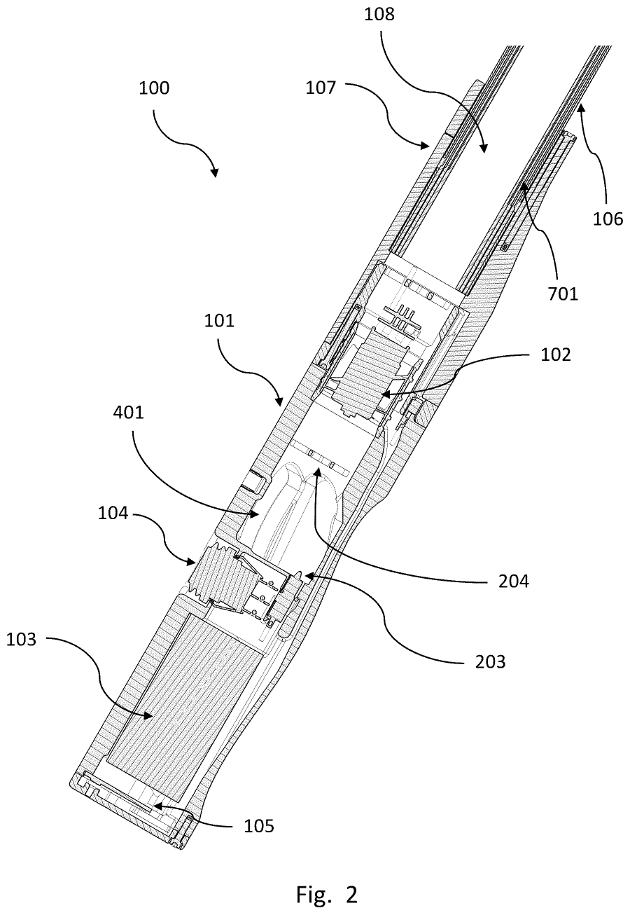

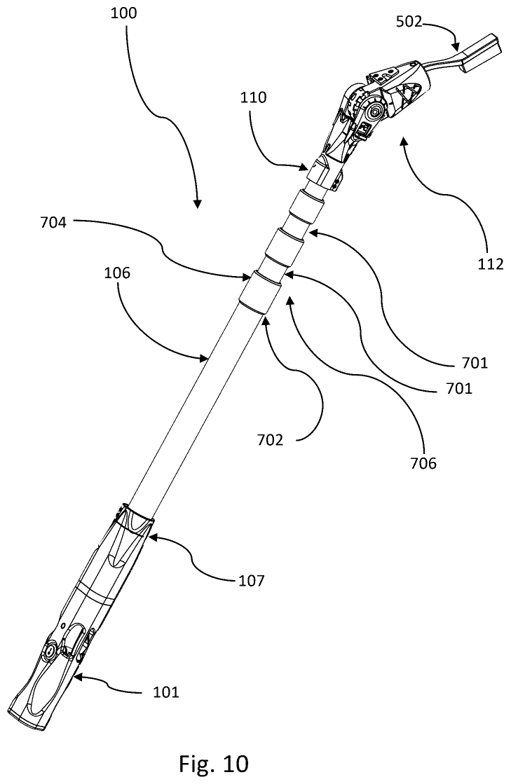

As shown in FIGS. 2 and 10, in some cases, the cleaning device 100 comprises a pole 106 that is a telescoping pole, and is comprised of a plurality of nested sections 701, that are hollow that can slide relative to one another to adjust the overall length of the device. In some cases, a locking mechanism 706 contemplated to secure the sections at a user-selected length. The locking mechanism can be any of several types known in the art. For example, a twist-lock mechanism may be used, wherein rotating one section relative to another engages an internal friction or cam lock. In some cases, a screw-lock mechanism 702 may be utilized; wherein each of the plurality of nested sections 701 comprises a collar 704 that can be tightened by the user causing friction between the plurality of nested sections 701 thereby adjustably securing a length the pole 106. In some embodiments, a lever-lock or flip-lock mechanism may be employed, where an external lever operates a clamp that tightens around an inner pole section

In various embodiments, the fan 102 may be an axial fan, which moves air parallel to its axis of rotation, or a centrifugal fan (also known as a radial fan or blower), which draws air in and directs it outward at a right angle. In some cases, the fan 102 is driven by an electric motor, such as a brushless or brushed DC motor. In some cases, the fan 102, may be operable at variable speeds.

In some aspects, electrical power for the device is provided by one or more batteries housed within the grip (in some cases, collectively the “battery”). In some cases, the battery 103 is preferably a rechargeable type to allow for repeated use. The battery chemistry may include, but is not limited to, lithium-ion (Li-ion), lithium-polymer (Li—Po), Nickel-Metal Hydride (NiMH), or Nickel-Cadmium (NiCd). In a preferred embodiment, a lithium-ion or lithium-polymer battery pack is used due to its high energy density, light weight, and long service life.

In some aspects, the battery 103 may consist of a single cell or multiple cells connected in series and/or parallel to achieve the desired operational voltage and capacity. In some aspects, the battery 103 has a triangular prismatic shape, and the housing that comprises the grip 101 may reflect a triangular prismatic shape in connection with the shape of the battery 103. The cleaning device 100 may also include a charging port, such as a USB-C or proprietary connector, allowing the battery 103 to be recharged from an external power source.

In some aspects, user control of the device is facilitated by the switch 104, which is operably connected to the battery 103 and the fan 102 via a printed circuit board (PCB 105). The switch 104 can be any of a variety of types, including a mechanical push-button switch, a slide switch, a toggle switch, or a trigger-style switch. In some embodiments, the switch may be a simple on/off control. In some embodiments, the switch may allow for variable speed control of the fan, either through a potentiometer integrated with the switch or by cycling through discrete speed settings managed by the PCB 105.

The PCB 105 serves to electrically connect and mechanically support the electronic components, which may include a microcontroller, motor driver circuitry, and a battery management system (BMS) for monitoring charge levels and protecting the battery from overcharge, over-discharge, and thermal events. In some cases, the PCB 105 may also control one or more Light Emitting Diode (LED) lights on the exterior of the grip 101 to indicate battery charge level. In some cases, the BMS may be packaged with the battery 103. In some cases, embodiments disclosed herein may contain multiple printed circuit boards which may be configured to control the fan 102. It is contemplated that that grip 101 may also include a printed circuit board configure to operate battery USB-C charging operation.

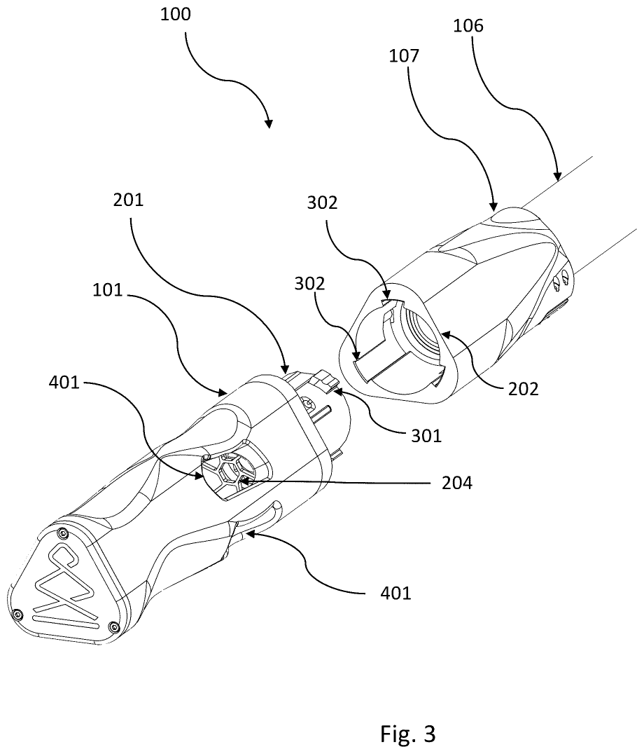

As shown in FIG. 3, in some aspects, the cleaning device further includes a pole 106 having a proximal end 107 coupled to the grip 101. Coupling is contemplated to be achieved by sleeve interaction between the grip 101 and the proximal end 107, wherein the grip as a smaller diameter region that can sleeve inside a corresponding cavity on the proximal end 107.

As Shown in FIGS. 1, 7, and 8, in some aspects, the pole 106 has a distal end 110, and inside the pole 106 there is a first internal channel 108 configured to receive air from the fan 102. The first internal channel 108 runs along the inside of the pole 106, according to some embodiments. The first internal channel 108 may connect in airtight compression fitting with the head portion 112.

In some cases, the cleaning device 100, may be used to remove debris from the climbing surface by directing air leaving the head portion 112 towards the climbing surface to remove debris. In some embodiments, the cleaning device 100 may also be used to evaporate moisture on the climbing surface and/or a user's hands. According to some embodiments, the cleaning device 100 may be used to evaporate moisture on a climber's hands whilst the climber is above the ground on the climbing surface, wherein a user may position the head portion 112 which may also include an aperture 113 that delivers the air out of the head portion 112. In some cases, a user may direct the aperture 113 so that the aperture 113 delivers air onto the climbing surface, and in an orthogonal direction across the bristles of the brush, according to some embodiments. The aperture 113 receives the air via the second internal channel 111, according to some embodiments.

In some embodiments, the head portion 112, which delivers air to the climbing surface, and may receive and hold a brush 502, and is comprised of: an articulating hinge 109 that defines a second internal channel 111, and this second internal channel 111 connects to, and receives air from, the first internal channel 108—the air being delivered via the fan 102.

In some aspects, head portion 112 is coupled to the distal end 110 of the pole 106 such that the fan 102 sends air drawn in at the grip 101, through the first internal channel 108 to the second internal channel 111, and through the inside of the articulating hinge 109 and out through the aperture 113 to remove chalk or debris from the climbing surface.

As shown in FIG. 3, In some aspects, the techniques described herein relate to a cleaning device 100, wherein the grip 101 is removably coupled to the proximal end 107 of the pole 106, via a rotatable locking mechanism, which includes a plurality of sliding nodules 301 on the grip 101, that insert into plurality of corresponding slots 302 located on the interior diameter of the proximal end 107, in some cases.

In some aspects, the techniques described herein relate to a cleaning device, wherein the grip 101 includes a housing portion 201 containing the fan 102, and wherein the housing portion 201 is configured to fit sleeved-inside a corresponding coupling 202 on the proximal end 107 of the pole 106. In some cases, the plurality of sliding nodules 301 are on the housing portion 201, and are configured to align the housing portion 201 as it slides inside the corresponding coupling 202 in a sleeve-like fit.

As shown in FIGS. 2, 3, and 4, in some aspects, the techniques described herein relate to a cleaning device 100, wherein the grip 101 further includes one or more air inlets 401 for drawing in ambient air, wherein the battery 103 and the switch 104 are located more distally from the pole 106 than the one or more air inlets 401, and wherein the one or more air inlets 401 are located more distally from the pole 106 than the fan 102. In some cases, the position of the one or more air inlets 401 is such that a user's hand gripping the grip 101 is substantially grabbing the region of the grip 101 comprising the battery, and the region defining the one or more air inlets 401 is between the user's hand and the fan 102.

In some cases, the grip 101 may comprise multiple switches, wherein in addition to the switch 104, the grip 101 further comprises a lockout switch 203 housed inside the grip, and accessible through the one or more air inlets 401, wherein a user can activate the lockout switch 203 to prevent the switch 104 being accidently manipulated during transport of the cleaning device 100. In some cases, the lockout switch 203 is located more distally from the pole 106 than the grill 204.

As shown in FIGS. 1, 5A, 5B, 6A, 6B, 9, and 10, in some aspects, the techniques described herein relate to a cleaning device 100 that has a slot 501 as a part of the head portion 112. In some cases, slot 501 is configured to hold a brush 502. The slot 501 can hold the brush via a friction fit or via an externally adjustable thumb screw 503.

According to embodiments of the present disclosure, the brushes that can be accommodated by the cleaning device 100 include, but are not limited to, climbing hold brushes, cleaning brushes, wire brushes, boar's hair brushes, horse hair brushes, nylon brushes or other synthetic bristle brushes. In some cases, the head unit may accommodate bristle brushes with or without a handle, and may be securely mounted via a securing element. The brushes' bristles may or may not be on the same side of the head as the air aperture.

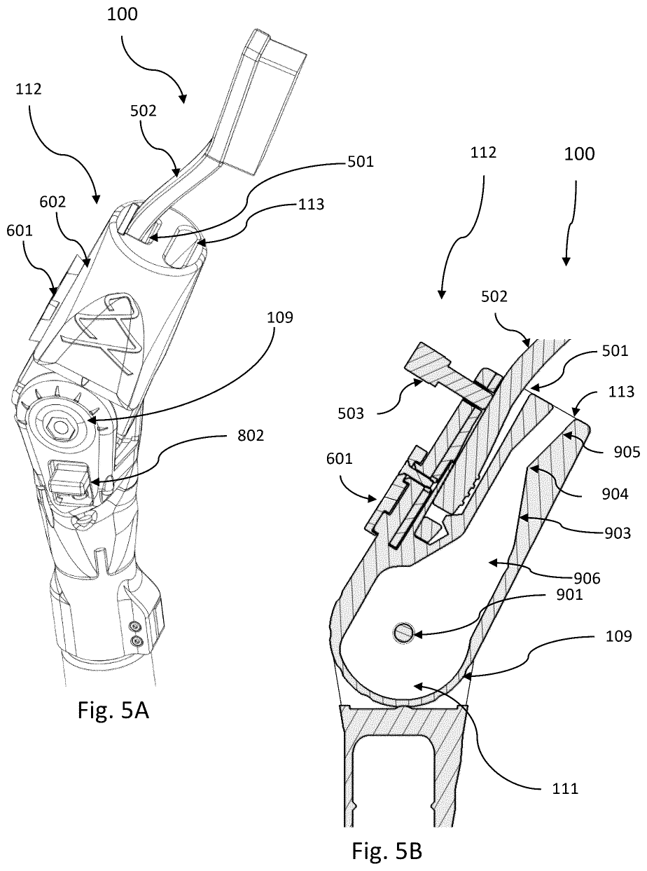

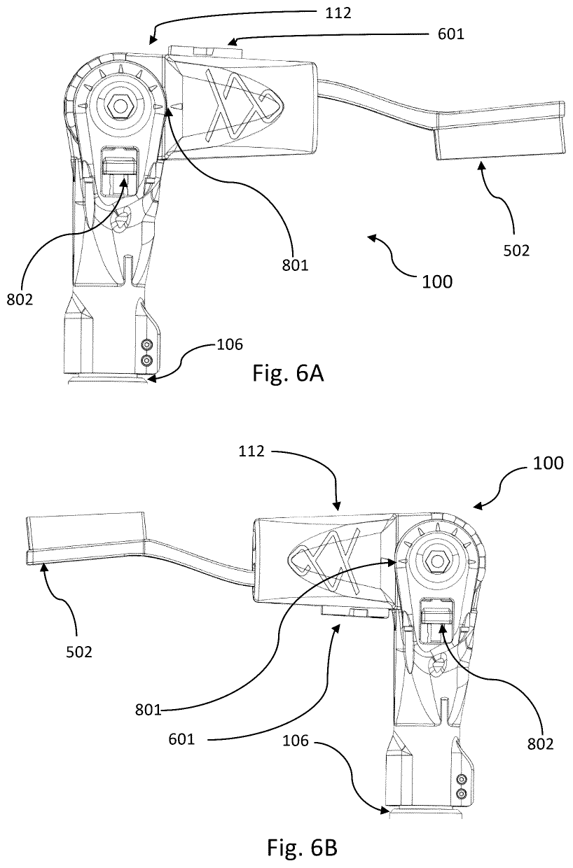

As Shown in FIGS. 5A, 6A, and 6B, in some aspects, the techniques described herein relate to a cleaning device 100, wherein the head portion 112 further includes a mounting plate 601 located on an exterior surface 602 of the head portion 112. In some cases, the mounting plate 601 is a standard quick release, metal mounting plate; wherein the interface between the mounting plate 601 and the surface of the head portion 112 make a substantially concave region to accommodate the corresponding quick-release bracket, enable to hold, by way of example, an additional brush, an action camera, a microphone, and/or a light.

As shown in FIGS. 5A, 6A, 6B, 7 and 9, in some aspects, the techniques described herein relate to a cleaning device, wherein the articulating hinge 109 is configured so that the brush 502 can be locked via a selector mechanism 802 into one of a plurality of angular positions 801 relative to the pole 106.

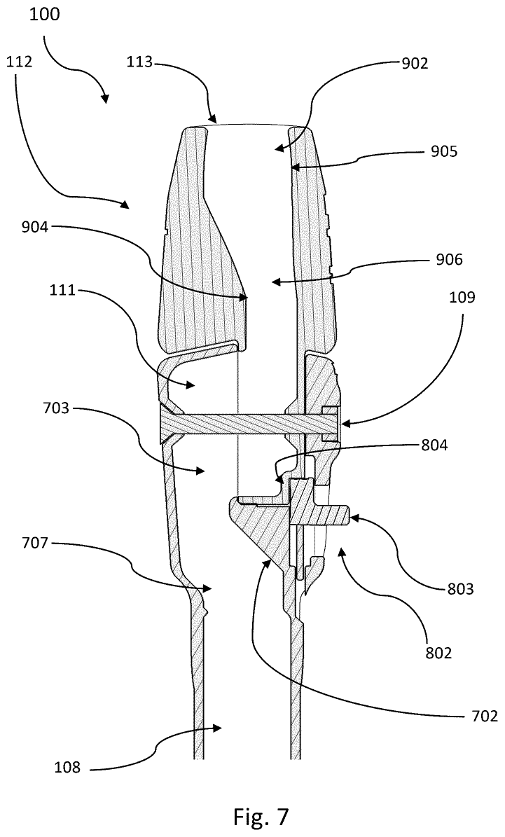

As shown in FIG. 7, in some aspects the selector mechanism 802 may have a latch 803 that the user manipulates in conjunction with the plate 804, which rotates as the articulating hinge 109 so rotates, and the user disengaging or engaging the latch 803 so that it connects with the plate thereby securing the brush 502 in one of the plurality of angular positions 801. In some cases, the plate 804 has a plurality of notches configured so that the latch 803 can be manipulated by the user to select a specific angular position of the head portion 112 in relation to the pole 106.

As shown in FIGS. 5B, and 7, in some aspects, the second internal channel 111 inside the articulating hinge 109 has several sections; a first section 707 that can transmit air from the internal channel to a second section 703 which then conveys the air around the pin 901 of the articulating hinge 109. The pin 901 passes through the second section 703 orthogonal to the flow of air inside the second section 703. Finally, the air goes into a third section 906 that connects to the second section 703, the third section has a nozzle 902, according to some embodiments. In some cases, the nozzle has a converging section 903, a throat 904, and an air diverting section 905. As the air passes through the third section 906 it goes through the nozzle 902 and out the aperture 113, according to some embodiments. In some cases, the throat 904 may be the beginning of an air diverting section 905 configured to collimate the air before said air exits the aperture 113. In a preferred embodiment, the air diverting section 905 is configured collimate air so that the air exiting the aperture 113 contacts the climbing surface in substantially the same location as the brush 502.

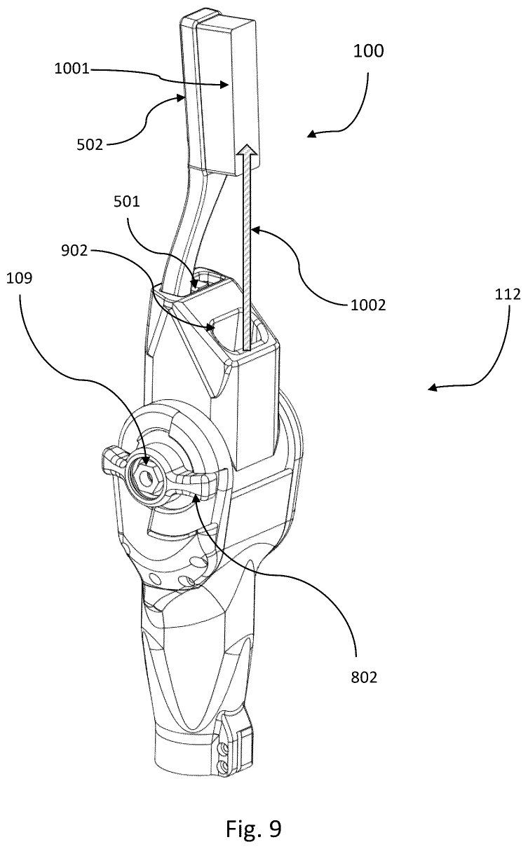

As shown in FIG. 9, in some aspects, the techniques described herein relate to a cleaning device, wherein brush 502 further includes bristles 1001 and the head portion 112, nozzle 902, aperture 113, and the slot 501 are together configured to communicate air from the aperture 113 in an orthogonal direction 1002 across the bristles 1001 of the brush 502, thereby effectuating the bristles to dislodge chalk and debris when the user makes a brushing motion with the cleaning device 100, and the air coming from the aperture 113, and blowing across the bristles 1001 would blow the chalk and debris away from the climbing surface in an orthogonal direction 1002 to orientation of the bristles 1001, and in line with the direction of the brushing motion by the user.

In some aspects, embodiments of the present disclosure include a cleaning device 100, wherein the aperture further includes a body and a tip, wherein the tip is configured to articulate a between first position and second position. In some cases, the tip may be removable and replaced with a secondary tip configured to deliver a specific spray pattern. In some cases, the secondary tip may include a hose configured to align along the bristle brush. According to some embodiments, the aperture 113 may integrate into the bristle brush thereby causing pressurized air to be delivered through the heel of the brush and onto the surface to be cleaned. In some cases, the air flows parallel to the length of bristles of the brush and out along the bristles in a substantially perpendicular direction to the surface being cleaned.

In some cases, the head portion 112 may include elements configured to couple with the grip 101, thereby allowing a user to use the cleaning device 100 without the pole 106, which may result in more cleaning power to remove debris, due to a lowered pressure-drop between the fan 102 and the aperture 113.

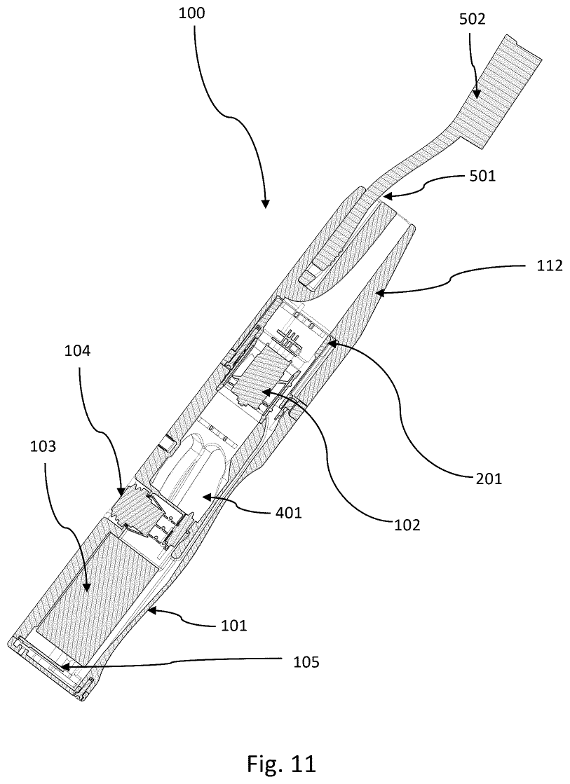

As shown in FIG. 11, in some embodiments, the grip 101 and head portion 112 may be coupled directly, wherein the grip 101 delivers air directly to the aperture 113. It is contemplated that in some cases the head portion 112 does not have an articulating hinge 109. In some cases, the head portion 112 is configured to directly receive the housing portion 201 of the grip 101, wherein a fan 102 communicates air from one or more air inlets 401 on the grip 101 to an aperture 113.

In some cases, the head portion 112 is configured to receive air from an air delivery system, wherein the air delivery system may comprise a grip 101.

In some aspects, embodiments of the present disclosure include a cleaning device 100 wherein the air delivery system comprise a pressure vessel. In some cases, grip 101 has a valve switch configured to modulate the release of pressurized air controllable by a user. In some cases, the air delivery system comprising a grip 101 may be configured to communicate with a hand pump including but not limited to: a rotary hand pump, a semi-rotary hand pump, a piston hand pump, a diaphragm hand pump, double diaphragm hand pump, and/or plunger hand pump. The hand pump may be detachable, and/or in some cases integrated into the grip 101 and/or the head portion 112. The air delivery system comprising a pressure vessel may be detachable, and/or in some cases integrated into the grip 101, so that said air delivery system communicates with the head portion 112.

In some aspects, embodiments of the present disclosure include a cleaning device 100 wherein the grip 101 and/or head portion 112 includes a coupling configured to connect with a mouthpiece. The mouthpiece may be configured to accommodate a user's mouth, lips, and/or provide a breath inlet configured to receive a user's exhaled breath. The mouthpiece may be detachable, or in some cases integrated into the grip 101.

In some aspects, embodiments of the present disclosure include cleaning device 100 wherein the head portion 112 and/or grip 101 includes a coupling configured to connect with a manual blower. The manual blower may be configured to be operated by a user, and can be detachable from the head portion 112 and/or grip 101. The manual blower is configured to be operated by a user, and may include, but is not limited to: a hand crank bellows, fireplace bellows, a hand crank blower, dust blower, a pump dust blower, blow out pump, and/or blow out bulbs

In some aspects, the techniques described herein relate to a method of cleaning a climbing surface, the method uses a cleaning device that has, at least: a pole having a proximal end coupled to a grip including: a fan, a battery, a switch, and a printed circuit board, wherein the battery is configured to power the fan via the switch and the printed circuit board; and a first internal channel configured to internally pass air from the proximal end to a distal end of the telescoping pole; the distal end being configured to couple with an articulating hinge that defines a second internal channel configured to communicate air with the first internal channel; and a head portion coupled to the articulating hinge, the head portion including an aperture configured to communicate air with the second internal channel, wherein the cleaning device is configured such that the fan communicates air from the grip, through the first internal channel of the telescoping pole, through the second internal channel of the articulating hinge, and out through the aperture to dislodge dust particles, debris, and/or chalk; affixing a brush into a slot on the head portion of the cleaning device; activating the fan by actuating the switch, thereby causing the fan to communicate air through the first internal channel, through the second internal channel, and out of the aperture; and directing head and the brush toward the climbing surface to dislodge debris therefrom.

In some aspects, the techniques described herein relate to a method, further including adjusting a length of the pole to reach a desired area of the climbing surface, via a telescoping embodiment of the pole.

In some aspects, the techniques described herein relate to a method, further including adjusting an angle of the articulating hinge to orient the head portion relative to the climbing surface.

In some aspects, the techniques described herein relate to a method, wherein affixing the brush further includes securing the brush in the slot via an externally adjustable clamp.

In some aspects, the techniques described herein relate to a method, further including removably fixing the grip to the telescoping pole, via sliding nodules on the grip housing into corresponding slots in the pole proximal end.

In some aspects, the techniques described herein relate to a method, further including: detaching the grip from the pole; and using the grip as a standalone blower. In some cases, the pole can be used for cleaning a rock-climbing surface without the grip attached thereto. In some cases, the method may include attaching the head portion directly to the grip thereby removing the pole from the cleaning device, but otherwise still operable in all functions as disclosed herein.

In some aspects, the techniques described herein relate to a method, further including: detaching the grip from the telescoping pole; and electrically coupling the grip to a power source to charge the battery. In some cases, the method includes detaching the grip from the pole by rotating the grip and pole in opposite directions, then the grip and pole pulling apart.

In some aspects, the techniques described herein relate to a method, wherein the climbing surface is an outdoor rock, including but not limited to: igneous, metamorphic, or sedimentary, and/or conglomerates thereof.

In some aspects, the techniques described herein relate to a method, wherein the climbing surface is an indoor rock-climbing hold, such as a plastic urethane hold, a volume, or a composite hold.

In some aspects, the techniques described herein relate to a cleaning device, including: a grip including an air inlet and a handle; an elongated body extending from the grip to a head portion, the elongated body defining an enclosed airway in communication with the air inlet; a cavity configured to accommodate brush handle; and an aperture located at the head portion and in communication with the enclosed airway.

For the avoidance of doubt the terms ‘comprise,’ ‘comprising,’ ‘comprises,’ and grammatical variations thereof are intended to have, at least, an open-ended meaning equivalent to ‘include,’ ‘including,’ ‘includes,’ and grammatical variations thereof. Accordingly, these terms are to be construed as specifying the presence of the stated features, integers, steps, or components, but do not preclude the presence or addition of one or more other features, integers, steps, or components.

What is claimed is:

1) A cleaning device, comprising:
a grip comprising a fan, a battery, and a switch;
wherein the battery is configured to power the fan via the switch;
a pole having a proximal end coupled to the grip and a distal end, wherein the pole defines a first internal channel configured to receive air from the fan; and
a head portion comprising: an articulating hinge that defines a second internal channel configured to communicate air with the first internal channel, an aperture configured to communicate air with the second internal channel;
wherein the head portion is coupled to the distal end of the pole; the fan is configured to communicate air from the grip, through the first internal channel to the second internal channel of the articulating hinge, and out through the aperture.

2) The cleaning device of claim 1, wherein the grip is removably coupled to the proximal end via a rotatable locking mechanism.

3) The cleaning device of claim 2, wherein the grip comprises a housing portion containing the fan, and wherein the housing portion is configured to fit sleeved-inside a corresponding coupling on the proximal end of the pole.

4) The cleaning device of claim 1, wherein the grip further comprises one or more air inlets for drawing in ambient air, wherein the battery and the switch are located more distally from the pole than the one or more air inlets, and wherein the one or more air inlets are located more distally from the pole than the fan.

5) The cleaning device of claim 1, further comprising:
a slot in the head portion, wherein the slot is configured to removably receive a brush; and an externally adjustable clamp mechanically coupled to the head portion and positioned to secure the brush within the slot.

6) The cleaning device of claim 5, wherein the head portion further comprises a mounting plate located on an exterior surface of the head portion.

7) The cleaning device of claim 1, wherein the pole comprises a plurality of nested sections and a locking mechanism to secure the pole at a user-selected length.

8) The cleaning device of claim 5, wherein the articulating hinge is configured so that the brush to be locked via a selector mechanism into one of a plurality of angular positions relative to the pole.

9) The cleaning device of claim 1, wherein the second internal channel defined by articulating hinge comprises: a first section configured to communicate air with first internal channel, the first section being configured to communicate air from the first internal channel to a second section configured to communicate air from the first section and about a pin of the articulating hinge, wherein the pin passes through the second section; and a third section defining a nozzle comprising a converging section, and a throat; wherein the third section is configured to communicate air from the second section and through the nozzle and out the aperture.

10) The cleaning device of claim 5, wherein brush further comprises bristles and head portion and the slot are configured to communicate air from the aperture in an orthogonal direction across the bristles of the brush.

11) A method of cleaning a climbing surface, the method comprising:
providing a cleaning device comprising:
a pole having a proximal end coupled to a grip comprising: a fan, a battery, a switch, and a printed circuit board, wherein the battery is configured to power the fan via the switch and the printed circuit board;
and a first internal channel configured to internally pass air from the proximal end to a distal end of the pole;
the distal end being configured to couple with an articulating hinge that defines a second internal channel configured to communicate air with the first internal channel; and a head portion coupled to the articulating hinge, the head portion comprising an aperture configured to communicate air with the second internal channel, wherein the cleaning device is configured such that the fan communicates air from the grip, through the first internal channel of the pole, through the second internal channel of the articulating hinge, and out through the aperture to dislodge dust particles; and
affixing a brush into a slot on the head portion of the cleaning device;
activating the fan by actuating the switch, thereby causing the fan communicate air through the first internal channel, through the second internal channel, and out of the aperture; and
directing head and the brush toward the climbing surface to dislodge debris therefrom.

12) The method of claim 11, further comprising adjusting a length of the pole to reach a desired area of the climbing surface.

13) The method of claim 11, further comprising adjusting an angle of the articulating hinge to orient the head portion relative to the climbing surface.

14) The method of claim 11, wherein affixing the brush further comprises securing the brush in the slot via an externally adjustable clamp.

15) The method of claim 11, further comprising removably fixing the grip to the pole.

16) The method of claim 11, further comprising:
detaching the grip from the pole; and
using the grip as a standalone blower.

17) The method of claim 11, further comprising:
detaching the grip from the pole; and
electrically coupling the grip to a power source to charge the battery.

18) The method of claim 11, wherein the climbing surface is an outdoor rock.

19) The method of claim 11, wherein the climbing surface is an indoor rock-climbing hold.

20) A cleaning device, comprising:
a head portion comprising an aperture and configured to removably accommodate a brush; and
an air delivery system comprising a grip configured to communicate with the head portion;
wherein the grip and the head portion together define an enclosed airway in communication with the aperture via the air delivery system.
